(19) United States
(12) Patent Application Publication
(10) Pub. No.: US 2012/0131134 A1
(43) Pub. Date: May 24, 2012

(54) UE Initiated IUT Transfer Based on Policy

(75) Inventors: Xavier De Foy, Kirkland (CA); Kamel M. Shaheen, King of Prussia, PA (US)

(73) Assignee: INTERDIGITAL PATENT HOLDINGS, INC., Wilmington, DE (US)

(21) Appl. No.: 13/110,972

(22) Filed: May 19, 2011

Related U.S. Application Data
(60) Provisional application No. 61/347,021, filed on May 21, 2010.

(51) Int. Cl. G06F 15/16

(52) U.S. Cl. 709/217

(57) ABSTRACT

Systems, methods, and instrumentalities are disclosed to control an inter user equipment transfer (IUT). A first user equipment (UE) may control an inter user equipment transfer (IUT) associated with a communication flow currently terminated at the first UE. The first UE may receive an indication of an environment change. An evaluation of an IUT policy may be performed in response to the environment change. It may be determined that a second UE is preferred to receive the communication flow. An IUT operation may be performed in relation to the communication flow. For example, the communication flow may be transferred from the first UE to a second UE.

### CROSS-REFERENCE TO RELATED APPLICATIONS

This application claims the benefit of U.S. Provisional Patent Application No. 61/347,021, filed on May 21, 2010, the contents of which are hereby incorporated by reference herein.

### BACKGROUND

Multimedia application information, multimedia “flows” (which may be referred to as media flows, communication flows, or simply, flows), may be communicated to mobile nodes or user equipment (UE) across one or more wireless communication networks. A UE may include any device that may communicate with communications networks, including, but not limited to, mobile devices (e.g., cellular phones, mobile media devices, mobile computers, etc.), computing devices, media devices (e.g., video devices, audio devices, data devices, etc.), telephone devices (including landline devices), network devices, etc.

### SUMMARY

Systems, methods, and instrumentalities are disclosed that may control an inter user equipment transfer (IUT). A first user equipment (UE) may control an IUT associated with a communication flow, e.g., a communication flow currently terminated at the first UE. The first UE may receive an indication of an environment change. An environment change may include a location change. For example, a user of the first UE may start a video call on the way to work. The user may arrive at work while the call is still on-going. When the user/first UE arrive at the user's work location, an environment change may be indicated.

An evaluation of an IUT policy may be performed in response to the indication of the environment change. The IUT policy may be evaluated to determine how a communication flow is to be handled. The IUT policy may be stored on the first UE. The IUT policy may include policy entries. The policy entries may comprise parameters, conditions, instructions etc., which may be used to determine actions relating to IUTs.

It may be determined that a second UE is preferred to receive the communication flow. Continuing the above example, the IUT policy may indicate that when the first UE is at the work location, the video portion (i.e., video communication flow) of a video call is to be terminated at a second UE, such as a computer screen, video projector, television screen, etc. Since the user is at the work location, a determination may be made that the second UE is preferred to receive the video communication flow.

An IUT operation may be performed in relation to the communication flow. For example, the communication flow may be transferred from the first UE to the second UE, e.g., the first UE may transfer the video communication flow of the video call to the second UE. A user may need to provide a confirmation before the IUT operation is performed.

An environment change may include a user action. For example, a user may initiate an IUT operation, such as a transfer of a communication flow from a first UE to a second UE. The user-initiated transfer may indicate that the second UE is not to transfer the communication flow back to the first UE based on one or more IUT policies. By preventing a transfer back to the first UE based on IUT policies, a ping-pong effect may be avoided (e.g., an IUT policy does not override a user's decision).

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D illustrates an exemplary process to deploy an IUT policy on a UE;

FIG. 2 illustrates a network selection based on registration of a new UE;

FIG. 3 illustrates a UE clearing a “User Triggered” flag on a flow;

FIG. 4 illustrates a network selection based on location change; and

FIG. 5 illustrates a network selection at session initiation.

### DETAILED DESCRIPTION

A detailed description of illustrative embodiments may now be described with reference to the Figures. However, while the present invention may be described in connection with exemplary embodiments, it is not limited thereto and it is to be understood that other embodiments may be used or modifications and additions may be made to the described embodiments for performing the same function of the present invention without deviating therefrom. In addition, the figures may illustrate call flows, which are meant to be exemplary. It is to be understood that other embodiments may be used. The order of the flows may be varied where appropriate. Also, flows may be omitted if not needed and additional flows may be added. Further, although the disclosed systems, methods, and instrumentalities may be generally illustrated herein with reference to an IUT policy, the embodiments are not limited to embodiments with a single IUT policy and can be extended to multiple IUT policies with multiple policy entries.

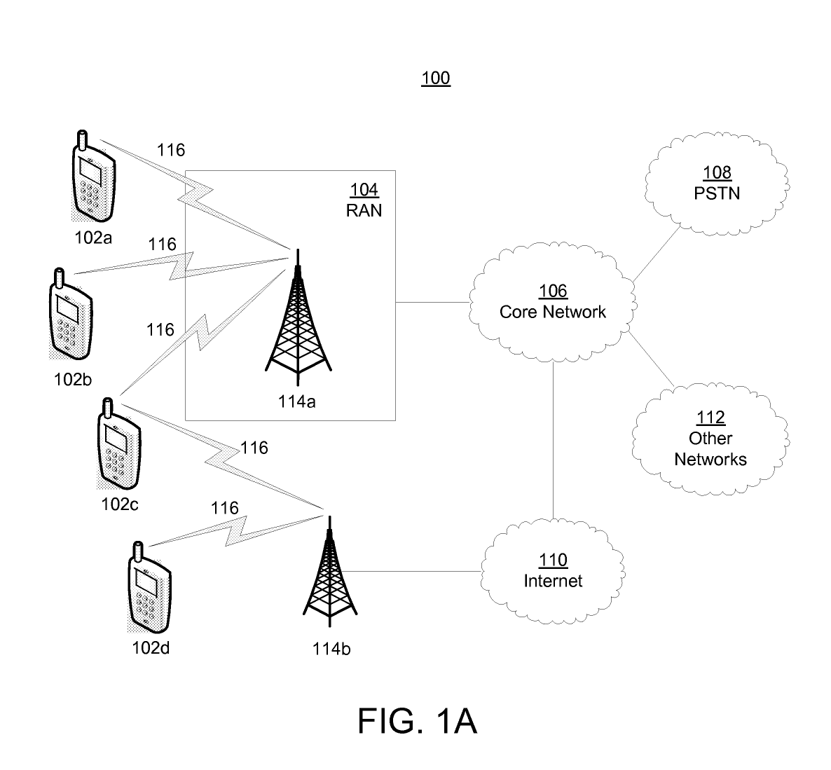

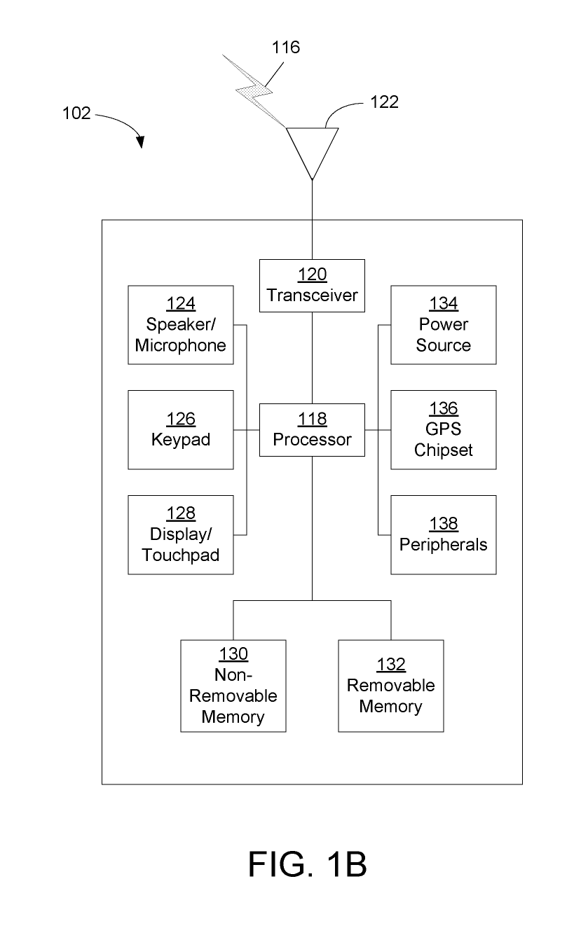

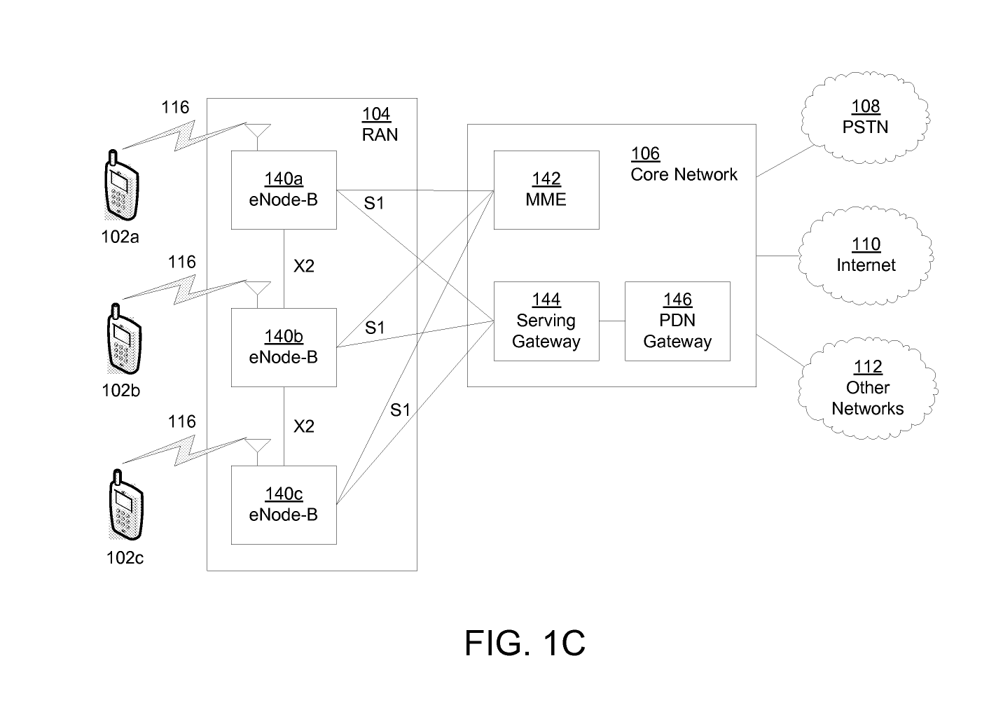

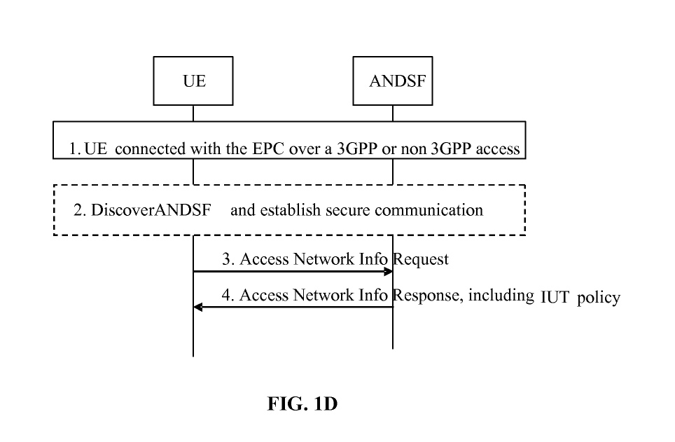

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an Si interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Systems, methods, and instrumentalities are disclosed that may control an inter user equipment transfer (IUT). A first user equipment (UE) may control an IUT associated with a communication flow, e.g., a communication flow currently terminated at the first UE. The first UE may receive an indication of an environment change. An environment change may include a location change. For example, a user of the first UE may start a video call on the way to work. The user may arrive at work while the call is still on-going. When the user/first UE arrive at the user's work location, an environment change may be indicated.

An evaluation of an IUT policy may be performed in response to the indication of the environment change. The IUT policy may be evaluated to determine how a communication flow is to be handled. The IUT policy may be stored on the first UE. The IUT policy may include policy entries. The policy entries may comprise parameters, conditions, instructions etc., which may be used to determine actions relating to IUTs.

It may be determined that a second UE is preferred to receive the communication flow. Continuing the above example, the IUT policy may indicate that when the first UE is at the work location, the video portion (i.e., video communication flow) of a video call is to be terminated at a second UE, such as a computer screen, video projector, television screen, etc. Since the user is at the work location, a determination may be made that the second UE is preferred to receive the video communication flow.

An IUT operation may be performed in relation to the communication flow. For example, the communication flow may be transferred from the first UE to the second UE, e.g., the first UE may transfer the video communication flow of the video call to the second UE. A user may need to provide a confirmation before the IUT operation is performed.

An environment change may include a user action. For example, a user may initiate an IUT operation, such as a transfer of a communication flow from a first UE to a second UE. The user-initiated transfer may indicate that the second UE is not to transfer the communication flow back to the first UE based on one or more IUT policies. By preventing a transfer back to the first UE based on IUT policies, a ping-pong effect may be avoided (e.g., an IUT policy does not override a user's decision).

An IUT policy may be deployed in a UE. The IUT Policy may be installed at provisioning time, defined and stored locally, etc. The IUT Policy may be installed and/or updated via download from an Access Network Discovery and Selection Function (ANDSF) (e.g., the IUT Policy may be installed at provisioning time and updated from the ANDSF when the IUT Policy is modified). An IUT Policy on the ANDSF may be configured by an operator. In addition, the IUT policy configuration may be based on user input through, for example, a web interface.

FIG. 1D illustrates an exemplary process to deploy an IUT policy on a UE. The UE may be connected with the network and establish secure communications with an ANDSF. The UE may send an information request, and may receive an information response that includes the IUT policy. The IUT policy may be installed and/or updated on the UE.

Following are exemplary illustrations of how an IUT policy may be used to provide for an automatic IUT.

A user may be at work and may start a video conference on a cellular phone. An IUT policy on the cellular phone may indicate that a projector at the user's work location is a preferred user equipment for a video flow when the user is at work and the projector is powered on. The IUT policy may indicate that the video flow be directed to the projector under such conditions. Further, the IUT policy may provide for monitoring and/or determining location, whether the projector is powered on, etc. The projector at the user's work location may not be powered on at the start of the video conference. Initially, the video flow may be directed to the cellular phone. If the projector is turned on during the video conference, the video flow may be automatically transferred to the projector in accordance with the IUT policy.

A user may be at home and start a video game on a portable computer. An IUT policy on the portable computer may indicate that a television in the user's home is a preferred user equipment for a video flow when the user is at home and the television is powered on. The IUT policy may indicate that the video flow be directed to the television under such conditions. Further, the IUT policy may provide for monitoring and/or determining location, whether the television is powered on, etc. In accordance with the IUT policy, if the television in the user's home was powered on when the user initiated the video game, the video flow may have been automatically sent to the television. Also in accordance with the IUT policy, if the television in the user's home was not powered on when the user initiated the video game, but was turned on during the video game, the video flow may have been automatically transferred from the cellular phone to the television during the video game.

A user, while in a car, may start a video conference on a cellular phone. An IUT policy on the cellular phone may indicate that a laptop computer at the user's home location is a preferred user equipment for a video flow when the user is at home and the laptop computer is connected to the network and powered on. The IUT policy may indicate that the video flow be directed to the laptop computer under such conditions. An IUT policy on the cellular phone may indicate that audio equipment at the user's home location is a preferred user equipment for an audio flow when the user is at home and the audio equipment is connected to the network and powered on. The IUT policy may indicate that the audio flow be directed to the audio equipment under such conditions. Further, the IUT policy may provide for monitoring and/or determining location, connected state of equipment, power state of equipment, etc. In accordance with the IUT policy, if the user arrives home and the laptop computer is on (or is later powered on), the video flow may be automatically switched to the laptop computer. In accordance with the IUT policy, if the user arrives home and the audio equipment is on (or is later powered on), the audio flow may be automatically switched to the audio equipment. Control of the audio and video flows may be separate. For example, the video flow may be may be automatically switched to the laptop computer when the IUT policy conditions for the video flow are met; however, the audio flow may stay with the cellular phone if the IUT policy conditions for transfer to the audio equipment are not met (e.g., the audio equipment is powered off, not connected to the network etc.).

Following are exemplary illustrations of how an JUT policy may be used to provide for a semi-automatic IUT.

A user may be at work and initiate a video conference on a cellular phone. An IUT policy on the cellular phone may indicate that a projector at the user's work location is a preferred user equipment for a video flow. When a video flow is to be established, the IUT policy may provide that the user is to be prompted to direct the video flow to the projector when the user is at work and the projector is powered on. The IUT policy may provide for prompting the user to turn on the projector if the user is at the user's work location and the projector is not powered on (e.g., when initiating the video conference at the user's work location, when arriving at the user's work location during a video conference, etc.). Further, the JUT policy may provide for monitoring and/or determining a user location, whether the projector is powered on, etc. In accordance with the IUT policy, the user may be prompted when initiating the video conference. For example, if the projector is on, the user may be asked (e.g., prompted) whether the video flow should be transferred to the projector. If the projector is not on, the user may be prompted to turn on the projector and be asked at the same time whether the video flow should automatically be transferred to the projector upon detecting that it has been powered on. The user may be asked, after turning on the projector, whether the video flow should be transferred to the projector.

A user may be at home and initiate a video conference on a cellular phone. An IUT policy on the cellular phone may indicate that a television in the user's home is a preferred user equipment for a video flow when the user is at home. In addition, an IUT policy on the cellular phone may indicate that audio equipment in the user's home is a preferred user equipment for an audio flow when the user is at home. When a video and/or audio flow is to be established, the IUT policy may provide that the user is to be prompted to direct the audio and/or video flow to the audio equipment and/or television respectively, when the user is at home. Further, the IUT policy may provide for monitoring and/or determining a user location, whether the television is powered on, whether the audio equipment is powered on, etc. In accordance with the IUT policy, if the audio equipment and/or television in the user's home was powered on when the user initiated the video conference, the user may be asked whether the audio flow should be transferred to the audio equipment and/or whether the video flow should be transferred to the television. Also in accordance with the IUT policy, the user may be prompted to turn on the audio equipment and/or television and be asked at the same time whether the audio and/or video flow should be automatically be transferred to the audio equipment and/or television upon detecting a powered on state of the respective equipment.

An IUT policy may comprise one or more policy entries. In addition, each policy entry may comprise one or more of the following: a type of media or group of media to which the policy entry applies; a prioritized list of UEs that may be used as end points for flows; for each UE in the list, or globally for all UEs in the list, one or more IUT operations that may be performed (e.g. transfer flow(s), add flow(s), replicate flow(s), etc.); one or more validity scope parameters, e.g., the validity scope parameter(s) may include one or more of the following: time period validity, geographical validity, network-based validity; a priority value for the policy entry (the priority value may also be implicit, through declaration order for example), wherein the priority value may be used in case two policy entries are valid at the same time for a given flow, such as to determine which one applies; automation parameters, e.g., if and/or when to prompt a user relating to an IUT transfer; or a DRM Policy.

A policy entry may include information relating to a DRM policy. For example, the policy entry may include one or more of the following: a list of an associated UE or UEs that are able or unable to receive DRM protected content, which may include a specific DRM scheme, e.g. OMA DM 2.0; for UE(s) able to receive DRM protected content, information that may facilitate flow transfer, such as a protocol used to negotiate secure flow transfer, e.g. OMA SCE 1.0; or additional limitations, such as a maximum number of replications or transfers (these limitations may apply for all content or for a specific content, for all UEs or specific UE(s)).

Other additional limitations may be useful, for example, in a context where the UE may be owned by a corporation and used by an employee, to restrict sharing of company private DRM protected content to selected devices within the company.

The IUT policy may be evaluated periodically and/or when the environment changes. For example, the IUT policy may be evaluated (or reevaluated) when: an action associated with a flow is taken relating to the UE that includes the IUT policy (e.g., a flow is initiated by the UE, a flow is transferred to the UE, a flow is replicated on the UE, etc.); receiving information that indicates a UE entered, left or is unavailable to the network; there is a change in location; and/or a time period has elapsed (e.g., set time periods, default time periods, the ending of a period of validity, etc.); and/or a user action (e.g., a user-initiated flow transfer).

An applicable IUT policy may be determined at a time when a media flow is initiated. For example, relating to an initial IUT operation, a UE that initiates the flow may use its own IUT policy to trigger an IUT transfer or other IUT operation (i.e., the IUT policy of the UE that initiates the flow may be the applicable IUT policy). As another example, still relating to an initial IUT operation, a UE initially terminating the flow or receiving an initial invite may use its own IUT policy to trigger an JUT transfer or other IUT operation.

After an initial IUT operation, the JUT policy may still be evaluated and may trigger new IUT operations. For example, relating to a collaborative session (CS), once the initial transfer (or replication) occurs, the controller may be the UE authorized to perform a policy based operation on the controlled flows. As another example, for the case when a collaborative session has not been created, further operations may be conducted as an initial IUT operation (e.g., under the control of the UE currently terminating the flow).

Unwanted IUTs, such as ping-pong flow transfers (e.g., a user transfers flow, but an IUT policy causes the flow to transfer back), may be avoided. For example, relating to a collaborative session, after a user-initiated transfer, the transferred flow(s) should be known to be “triggered by user” and unwanted IUT(s) may be avoided. When the user transfers the flow(s), information associated with the transfer may be stored by the Controller. Because the Controller may know the flow was moved by the user, the Controller may not transfer the flow again based on preference in policy. This limitation may be lifted by the user on the Controller UE or by other action (e.g., the IUT policy may take effect when there is a location change, after a time period, etc.).

To avoid a ping-pong transfer relating to the case where there may not be a collaborative session, as an example, the destination UE may assume that an IUT was triggered by a user and set a flag. After such an assumption, the destination UE may not apply its IUT policy on the flow unless the user clears the flag to enable policy again for this flow. The destination UE may clear the flag in relation to an environment change.

Some JUT policy actions may be based on a UE having knowledge of status information of other UEs. As an example, knowledge of status information may be obtained via IMS Registration Package or Presence, as described in TS 23.237 v10.1.0, section 6a.8.2. In addition, other means may be used to obtain this information.

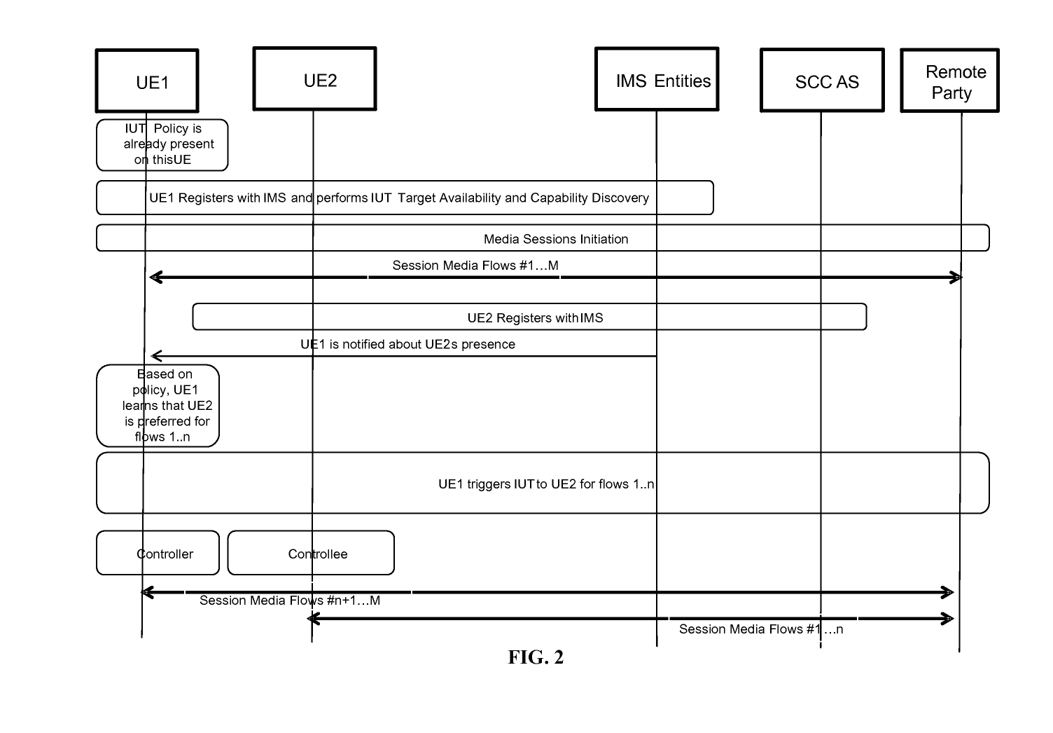

FIGS. 2-5 illustrate exemplary systems, methods, and instrumentalities used to control an IUT. FIGS. 2-5 may illustrate how an IUT Policy is used to make a decision and how the IUT policy evaluation may be triggered based on events from the network, the UE, the user, etc.

FIG. 2 illustrates a network selection based on registration of a new UE. For example, UE1 may have media flows (e.g., UE1 may be sending and/or receiving flows). UE1 may perform IUT Target Availability and Capability Discovery (e.g., as described in TS 23.237 v10.1.0, section 6a.8.2). UE2 may enter the network. For example, UE2 may register with the IP Multimedia Subsystem (IMS). UE1 may be informed and may decide to transfer one or more flows to UE2. UE1 may keep one or more other flows. As shown in FIG. 2, a controller/controlee relationship may be set-up between UE1 and UE2. However, such a relationship may not be set-up, and, once UE1 transfers a flow, UE1 may not retain control over the transferred flow.

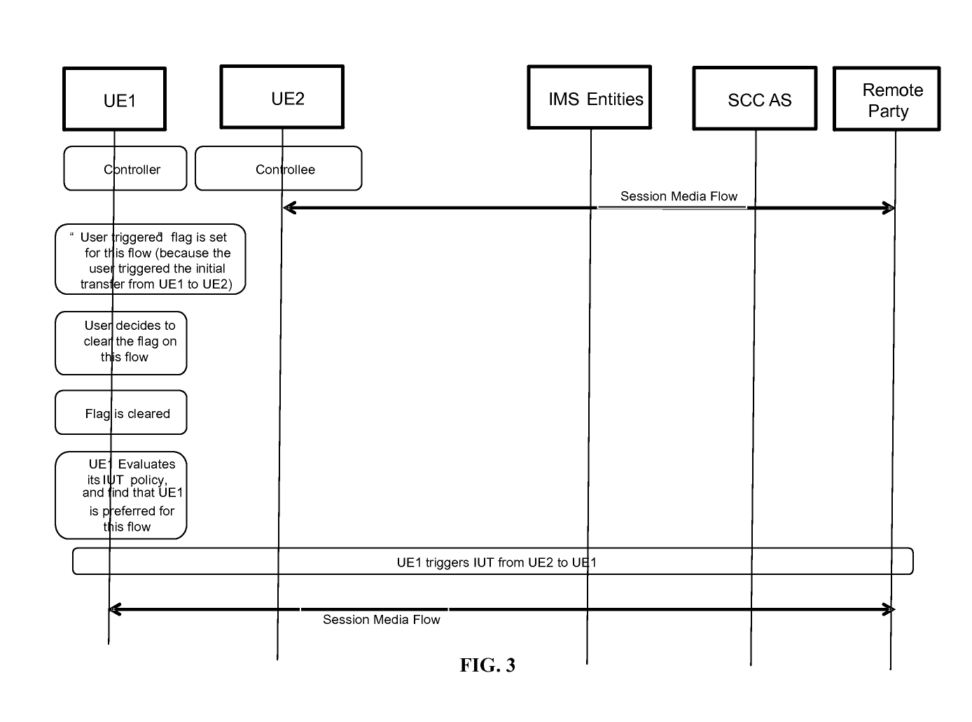

FIG. 3 illustrates a UE clearing a “User Triggered” flag on a flow. For example, a user of UE1 may already have triggered an IUT (transfer) of flow(s) to UE2. A flag may be set relating to the IUT. The flag may indicate that one or more IUT policies are not to be evaluated with respect to the transferred flow(s). UE1 may clear the flag in response to an environment change (e.g., a location change, a direct user decision, an indirect user decision, etc.). This action may be local on UE1. Because the flag has been cleared, UE1 may evaluate the one or more IUT policies and determine that UE1 is preferred for the flow(s). The flow(s) may be transferred to UE1.

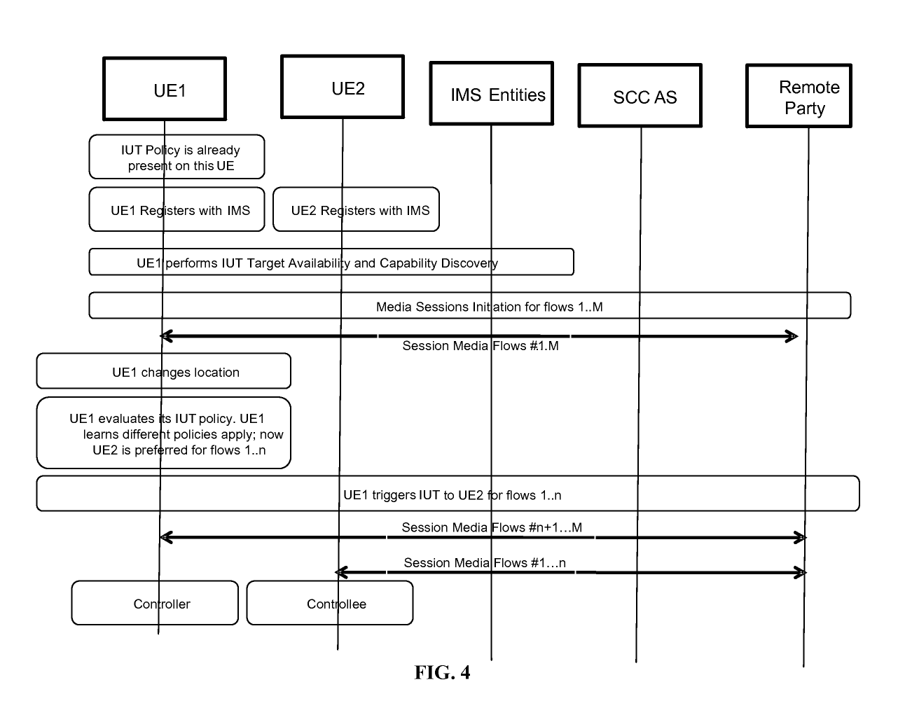

FIG. 4 illustrates a network selection based on a location change. UE1 and UE2 may be registered with the IMS. UE1 may perform IUT Target Availability and Capability Discovery (e.g., as described in TS 23.237 v10.1.0, section 6a.8.2). UE1 may have media flows. UE1 may change location, which may be an environment change that triggers an evaluation of an IUT policy. Because of the new location of UE1, UE2 may be preferred for one or more of the media flows. UE1 may trigger an IUT where the one or more flows are transferred to UE2. UE1 may keep one or more other flows.

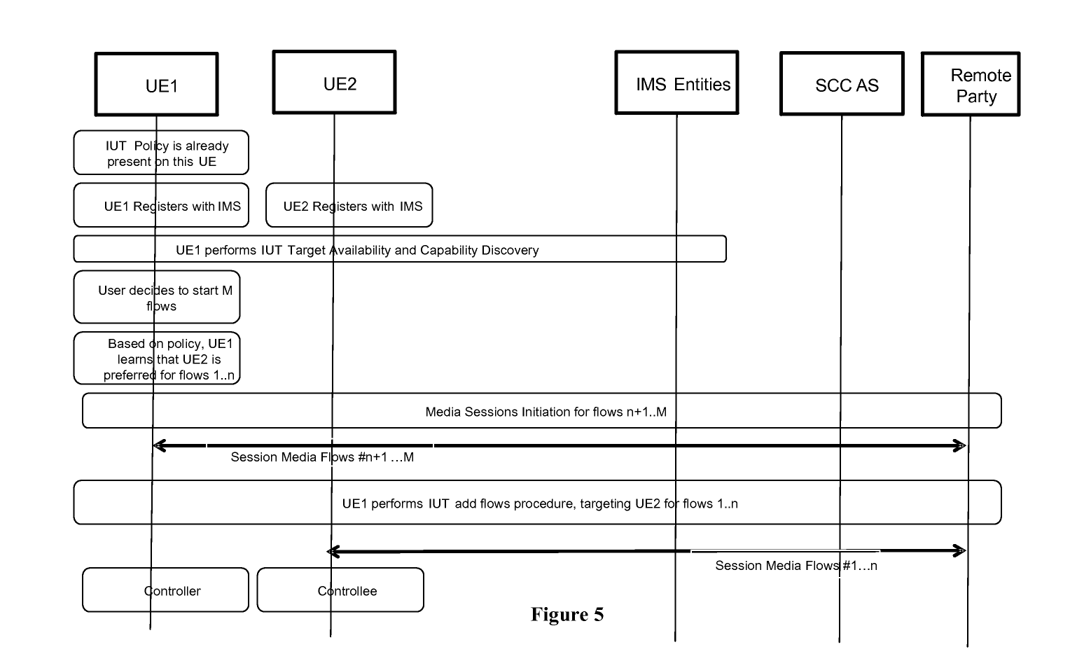

FIG. 5 illustrates a network selection at session initiation. For example, UE1 and UE2 may be registered in the network. UE1 may perform IUT Target Availability and Capability Discovery (e.g., as described in TS 23.237 v10.1.0, section 6a.8.2). A user on UE1 may decide to start a media session including several flows. UE2 is present and may have a higher priority for some of the flows (e.g., UE2 may be preferred one or more flows). In response, UE1 may directly add the one or more flows to UE2 (e.g., the one or more flows may not be transferred; they may be directly initiated at UE2, for example using a procedure such as the one described in TS23.237 version 10.1.0, section 6a.2.2).

While the various embodiments have been described in connection with the various figures, it is to be understood that other similar embodiments may be used or modifications and additions may be made to the described embodiment for performing the same function of the various embodiments without deviating there from. Therefore, the embodiments should not be limited to any single embodiment, but rather should be construed in breadth and scope in accordance with the appended claims.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method to control an inter user equipment transfer (IUT), the method comprising:
receiving an indication of an environment change;
evaluating an IUT policy by a first user equipment (UE) in response to the indication of the environment change;
determining that a second UE is preferred to receive a communication flow; and
performing an IUT operation relating to the communication flow.

2. The method of claim 1, wherein the JUT operation is at least one of a transfer, an addition, or a replication.

3. The method of claim 1, wherein the environment change is at least one of: a location change, a network entry, a network exit, a time period expiration, or a user action.

4. The method of claim 1, further comprising receiving a confirmation from a user relating to the IUT operation.

5. The method of claim 1, further comprising one of: downloading the IUT policy from an access network discovery and selection function or defining and storing the IUT policy locally.

6. The method of claim 1, wherein the JUT operation is a transfer of the communication flow to the second UE, and wherein the transfer is designated as a user-initiated transfer, and wherein the user-initiated transfer designation indicates that the second UE is not to transfer the communication flow back to the first UE based on one or more IUT policies.

7. The method of claim 1, wherein the JUT policy includes one or more of: a prioritized list of UEs, one or more types of media to which the IUT policy applies, a time period during which the IUT policy applies, a geographical area to which the IUT policy applies, or a network area to which the IUT policy applies.

8. The method of claim 1, wherein the JUT policy includes digital rights management (DRM) policy information, and wherein the DRM policy information includes one or more of the following: a list of UEs that are able to receive DRM protected content, a maximum number of transfers associated with the communication flow, or a maximum number of transfers associated with a UE.

9. A first user equipment (UE) to control an inter user equipment transfer (IUT), the first UE configured, at least in part, to:
receive an indication of an environment change;
evaluate an IUT policy in response to the indication of the environment change;
determine that a second UE is preferred to receive a communication flow; and
perform an IUT operation relating to the communication flow.

10. The first UE of claim 9, wherein the IUT operation is at least one of a transfer, an addition, or a replication.

11. The first UE of claim 9, wherein the environment change is at least one of: a location change, a network entry, a network exit, a time period expiration, or a user action.

12. The first UE of claim 9, further configured to receive a confirmation from a user relating to the IUT operation.

13. The first UE of claim 9, further configured to download the IUT policy from an access network discovery and selection function or define and store the IUT policy locally.

14. The first UE of claim 9, wherein the IUT operation is a transfer of the communication flow to the second UE, and wherein the transfer is designated as a user-initiated transfer, and wherein the user-initiated transfer designation indicates that the second UE is not to transfer the communication flow back to the first UE based on one or more IUT policies.

15. The first UE of claim 9, wherein the IUT policy includes one or more of: a prioritized list of UEs, one or more types of media to which the IUT policy applies, a time period during which the IUT policy applies, a geographical area to which the IUT policy applies, or a network area to which the IUT policy applies.

16. The first UE of claim 9, wherein the IUT policy includes digital rights management (DRM) policy information, and wherein the DRM policy information includes one or more of the following: a list of UEs that are able to receive DRM protected content, a maximum number of transfers associated with the communication flow, or a maximum number of transfers associated with a UE.
